(19) United States
(12) Patent Application Publication
(10) Pub. No.: US 2005/0058811 A1
(43) Pub. Date: Mar. 17, 2005

(54) Joined web business form construction having removable elements

(76) Inventor: Jesse D. Crum, St. Fort Scott, KS (US)

Correspondence Address: WARD KRAFT, INC., P.O. BOX 938, FORT SCOTT, KS, 66701, US

(21) Appl. No.: 10/832,953

(22) Filed: Apr. 27, 2004

Related U.S. Application Data
(63) Continuation-in-part of application No. 10/663,131, filed on Sep. 16, 2003.

(51) Int. Cl. B32B 3/00

(52) U.S. Cl. 428/192

(57) ABSTRACT

The present invention relates to a business form construction created from differential substrates that has been provided with one or more removable elements such as cards, labels, tags and the like. The form construction is desirably a composite form having at least first and second discrete portions one of which carries one or more removable elements and the other of which provides an information carrying portion. The business form construction of the present invention includes a bonding material that secures the first and second portions to one another in an adjacent manner. The bonding material is covered with a coating which prevents peppering or tracking of toner during subsequent processing through a laser printer or ion deposition print engine.

### CROSS-REFERENCES TO RELATED APPLICATIONS

This is a continuation in part of commonly assigned U.S. Ser. No. 10/663,131, filed Sep. 16, 2003, the disclosure of which including that found in the claims is incorporated herein by reference.

### FIELD OF THE INVENTION

The present invention relates to a business form construction created from different and separate substrates that has been provided with one or more removable elements such as cards, labels, tags and the like. The unique form construction of the instant specification is desirably a composite form, formed from two different types of material, having at least first and second discrete portions one of which carries one or more removable elements and the other of which may provide an information carrying portion or may also contain detachable identification pieces. The substrates used in the construction of this business form are aligned adjacent to one another and then joined through a unique combination of materials and process in which an adhesive element is initially provided to secure the components or sections together and then the adhesive portion is over coated to preclude the form from becoming contaminated with toner particles during the imaging or processing of the business forms through laser printers and ion deposition imaging devices, which has been commonly referred to as “peppering” or “tracking.”

### BACKGROUND OF THE INVENTION

Information carrying structures such as business forms with removable cards, tags and labels have long been used to convey information to the holder, presenter or recipient of the business form. Business forms have heretofore been provided with removable cards and such cards can be utilized in any number of areas. Some exemplary uses of these detachable cards include but are not limited to insurance, medical, identification (ID cards), membership applications, admissions, tickets, collections, special events, credit or debit cards, temporary passes and the like.

One traditional means used to deliver cards was to place the card in a carrier that had cut out notches to receive two or more corners of the card and then deliver the card through the mail, by use of a courier or by such other means in order to place the card in the possession of the intended recipient. However, while effective in delivering the card to the end user, the process of assembling the mailing could be cumbersome in that it required the carrier to be printed and then to subsequently cut notches in the carrier to create areas to hold the corners of the card and then, finally placing of the card in the carrier. Next, the carrier was typically folded and then usually placed in an envelope prior to mailing the card to the recipient. In addition to being a somewhat cumbersome manufacturing process, the process itself can be expensive, in that it requires a number of pieces, a supply of cards, carriers and envelopes. Thus, there has been a continuing trend to move away from such processes and reduce the number of separate components and steps required to prepare such a business form construction.

Another exemplary form construction by which to deliver cards that arose out of the need to reduce such processing complexities as discussed above was to simply affix the card to the top surface or uppermost portion of the sheet of paper or the like. This product configuration eliminated the need to die cut notches in the carrier to create an area to receive the card as well as the step of having to align and place the corners of the card within the cut out area of the carrier.

In this exemplary construction, those where the card rides on top of the surface of the substrate, the card was normally affixed to the sheet of paper through the use of a spot adhesive or other pattern of adhesive that would hold the card in place during handling and transport, but which would allow the card to be readily removed by the recipient. Alignment was not a particularly critical concern and hence processing speeds improved. However, this construction, while eliminating some of the drawbacks associated with the above mentioned arrangement of putting a card into a carrier assembly, still suffered from unforeseen difficulties and created new problems in that the card was placed on the surface of the sheet of paper which then created a raised area which was disproportionate to the surrounding area. Such a situation or arrangement often resulted in jamming of the printer or feeding apparatus when attempting to image or process the paper substrate with the card attached. Unfortunately, while this particular construction resulted in manufacturing efficiencies it created difficulties for the end users as such product configurations had to be carefully or even gingerly fed through the printer, again slowing distribution to the end user and resulting in significant frustration of the end user or printer of the form construction.

In a still further effort to overcome the above-mentioned problem of differential thicknesses created by the inclusion of the card on the surface of the paper or substrate, manufacturers then sought to create holes, pockets or die cut areas in a substrate that corresponded in size and shape to the card that was to be placed into the receiving area. In such a construction, when the card was placed into a receiving area, the card would not rest above the level of the surface of the paper substrate, but instead may extend below the bottom surface of the sheet of paper. Once again the manufacturer, while solving the problem of having the card extend above the surface of the sheet, faced the problem of alignment and having to carefully position the card within the receiving area.

In addition to problems associated with alignment, the manufacturer also faced the problem of also having to hold and secure the card in the receiving area. As such and in order to hold the card in place in the carrier, another web of material was affixed over the hole in the form of a patch, a continuous strip that ran edge to edge or segments of material that would hold the card in position, see for instance U.S. Pat. No. 5,403,236. While effective in over coming the problem with the card being placed on top of the substrate, such a construction then suffered from additional problems.

The addition of the supplemental material over the area of the cut out to receive the card again created a raised portion that extended either below the surface of the paper or alternatively both above and below the surface of the paper, depending upon the thickness of card structure. Again, the construction could still only be fed in a small amount to the printer as the area of double thickness around the card area created a hump, or a sloped configuration when several card carrying sheets were placed in a stack. This limited the amount of cards that could then be placed in the tray to be fed to the printer or processing equipment.

A still further solution to the above-mentioned dilemma was to create a calendared area or recess in the paper substrate, by crushing an area of the paper that corresponded to the size of the card. The card was then placed within the substrate. This eliminated the need to apply a patch to hold the card in the area of a cut out into which a card would be inserted; however, this construction still suffers from other drawbacks. The thickness of the card material is still more than the thickness of the paper substrate. As such, the top surface of the card would still be above the top surface of the paper substrate leading to an arrangement that still suffered from difficulties in processing the card due to the differential thickness arising out of the card sticking out of the well or recessed area. In addition, the manufacturer still had to accurately align the construction so that it would fit within the area of the recess or well.

Other solutions included simply cutting cards from a sheet of paper stock. However, such cards are generally undesirable in that they are subject to being easily torn or destroyed and thus have only limited use or application.

A still further business form and card construction was then contemplated to eliminate the need to align and place a card, usually plastic, in a well, recess, die cut area, etc. This solution was to simply affix a web of card material, again usually plastic, to the substrate. This enabled the manufacture to die cut the material directly in line with the imaging of the information carrying portion of the construction. However, such constructions while attractive from a manufacturing perspective also did not completely solve the processing of the form construction.

The web of card material still needed to be connected to the portion or web of information carrying material. In one arrangement, one web is affixed or partially juxtaposed directly onto an edge or side of the other portion by adhesive, crimping, mechanical fastening or the like. As expected however, this arrangement creates a bump in the form and contributes again to processing difficulties in attempting to feed the construction through the printer. Again, such arrangements had to be carefully processed through the printer and only a few forms at a time could be stacked into a feed tray for a printer or processing equipment.

An attempt to resolve the problem of the discontinuous surface area was to place the webs next to or adjacent one another and then place a small strip of material, such as tape to connect the two webs together. While this solved some additional problems for card manufacturers and end users, still other problems persisted. The tape used to connect one portion of the assembly to the other, during processing, would ooze adhesive to the edges of the tape due to the pressure applied by the rollers or belts in the printing apparatus. The adhesive would then inadvertently catch toner particles that causing problems generally referred to as “tracking” or “peppering” both of which are undesirable in delivering a product to an end user recipient.

There are number of laser printer, ion deposition print engines, such as those offered by Xerox Corporation, Hewlett Packard and others in which loss or excess toner from one printed sheet may collect on imaging rollers, belts and the like. This excess toner may inadvertently come into contact with portions of subsequent forms that are traversing the system. Much of the toner that is applied to a form by inadvertent contact will fall off on prior processing, however with those areas of a form that may have exposed adhesive, such as with labels or joined webs, the toner will cling to any exposed adhesive causing tracking or peppering of the form and resulting in the form being discarded by the processing facility as the form appears “dirty.”

A yet still further card arrangement was to provide a single sheet of paper and then apply a plastic coating over the area from which the cards were to be created such as through the use of die cutting or the like. While this eliminated problems related to joining discontinuous materials, it reverted to the problem associated with having a heightened thickness of material in the area of the cards again giving rise to a discontinuous stacking arrangement and other difficulties enumerated above, such as static build up and toner, ink, and adhesive holdout.

An additional processing problem also resulted from the use of such prior art constructions. Such constructions, due to the difficulty in feeding the forms, required the forms to be fed in a portrait arrangement into the printer, that is in connection with a form size of 8½″ by 11″, the 8½″ side was fed to the printer first. By feeding the short side of the form into the printer first, the printer, which calculates wear of the print head based on the total running length of the print job, was subjected to additional wear in running a regular pass of product as opposed to being able to run a regular pass of forms when fed in a landscape, or long side first, arrangement through the printer. As can be expected, this also resulted in a further delay in processing the forms by the end user or printer as well as additional wear and tear of the print head.

What is needed therefore, is a business form card combination that overcomes the foregoing processing and handling difficulties, including those relating to peppering and tracking, and to provide a business form card configuration that is easy to use and presents a clean and consistent image to the recipient.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to business forms that are constructed from two dissimilar materials that form distinct or easily identifiable sections or portions of the form. The sections of the form are joined together so that the portions are arranged in an aligned or adjacent configuration and the sections do not overlap thereby creating a bump that must be handled by the processing equipment.

In one exemplary embodiment of the present invention, a business form construction, is described and includes a first generally planar substrate composed of a first material. The first substrate has first and second ends and first and second sides. A second generally planar substrate is also provided and is composed of a second material, that is distinct from the first material and has first and second sides and first and second ends. The second substrate has at least one die cut defining at least a first removable element. A material for securing the first and second substrates to one another along one of the first and second sides or first and second ends of each of the substrates is provided so that the substrates are connected in an adjacent and not overlapping configuration. Finally, a coating is applied over the material to prevent toner from substantially affixing to the material during imaging and to eliminate the occurrence of tracking or peppering.

In a still further exemplary embodiment of the present invention a method of producing a business form having at least one removable element is described and includes the steps of initially advancing first and second webs of material. Then the first and second webs are secured together along one end edge or side edge of each of the substrate through use of a bonding material. The webs are secured to one another so as to be adjacent with one another and not overlapping. Next, a coating is applied over the bonding material to prevent toner tracking or peppering and finally, the business forms are collected.

In this exemplary embodiment, the bonding material may be treated such as with corona energy after the bonding material has been applied. In addition, the coating may also be cured after it has been applied over the bonding material such as with UV energy. The business forms of this embodiment may also undergo a die cutting step to create one or more removable element as well as a sheeting step prior to collecting the forms so that individual business forms may be created.

In a yet still further exemplary embodiment of the present invention, a business form intermediate is provided and includes a first cellulosic sheet having side edges and end edges. The form construction also includes a second sheet having a synthetic component and having side edges and end edges. An adhesive bonding material is used to connect the first sheet to the second sheet along one of the side edges or the end edges such that the first and second sheets do not overlap with one another and are adjacent each other. A coating is then applied over the bonding material so as to cover at least edges of the bonding material.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a side elevation of the form construction having the material and coating used in securing the form parts one to another;

FIG. 2 shows a schematic of the manufacturing processed used in the production of form products described herein;

FIG. 3 illustrates a front view of the business form construction of the present invention; and

FIG. 4 provides a block diagram of an exemplary method of producing the business form assembly of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been discovered that the use of coating solutions normally used in providing toner or ink anchorage can be used to prevent toner from adhering or affixing in those areas where it is generally not desired such as in those areas where exposed adhesive may otherwise cause toner to become affixed or attached to the surface of the business form.

The term “removable elements” refers to items such as cards, labels, chips, coins, tickets, tags and the like as well as portions of substrates that have a differential thickness compared with the remainder of the business form to which it is attached, connected or otherwise configured in arrangement therewith and may be removed from the form assembly.

It should be understood that the type, shape, number and arrangement of the removable elements is discretionary and any such configuration may be used depending on the needs of the end user or particular application for which the removable elements are intended. As indicated in the FIGURES a side by side arrangement of two cards is provided, or the cards may be a self-laminating construction. The cards or removable elements may be disposed one on top of the other or only a single element may be present. While the card is generally considered to be a “wallet sized” card, one about the standard dimensions of a credit card, the card could also be larger such as to form an informational placard or alternatively could be much smaller such as useful in connection with a key tag or the like.

The term “intermediate” as used herein includes generally a substrate this undergoes one or more processing steps such as printing, imaging, sealing, folding, cutting or the like.

The term “patterns” as used herein refers to continuous strips, sheets, lines, shapes, spots or elements, discontinuous segments, spots, shapes or elements as well as regular and irregular placement of such items. Patterns may also refer to combinations of the above mentioned items such that one pattern may be a continuous strip, another segmented elements and a still further an irregular placement of dots or the like. Any combination of patterns is possible depending on the need or application of the manufacturer or the end user. In additions, the pattern can be prepared in order to accommodate a particular theme, season, event, trade dress, and the like.

The patterns may be formed from strips, segments, dots, geometric elements of material. It is also desirable that the material and coating are selected so that they reduce surface affinity between the sheets, thereby enabling the sheets to release from the stack readily and facilitate the feeding and handling of the sheets by the printer or processing device.

The adhering or bonding material is used to secure the substrates together may be applied by flood coating, pattern or spot coating, transfer coating or other means known in the industry: The material may be the full length and width of the substrates or may be applied so that the edges of the material extend slightly beyond the pattern of the material laid down. The material used in this invention, refers to tape, adhesive, bonding agents and the like that can be applied to the substrates and used to hold the substrates to one another.

An exemplary tape that may be used in connection with the present invention to bond the webs, sheets or substrates together is an acrylic high performance tape available from Polybond, Corporation of Derry, N.H. and under the product number #114 PET tape. The tape is a polyester (PET) based material to which an acrylic adhesive has been applied. In order to reduce adhesive contamination, the tape is desirably cut using release coated blades on the slitter or other cutting mechanisms. Such release coating includes silicone, Teflon® and the like.

An exemplary coating that is applied over the surface of the bonding material that is suitable for use in connection with the present invention is Sericol® which is available from Sericol of North Kansas City, Kans. and includes acrylate ester, vinaly monomer, acrylated urethane, alkanol amine, barium sulfate and a photoinitator. Sericol® is a pigment less material having an absorbing agent contained therein as well as being in a prescribed pH range. Exemplary Sericol® blends include IJR-701-1 “white” and IJR-751-1 “matt clear.”

The securing or bonding material is over coated with the Sericol® through the use of a blade applicator, Meyer rod, anilox roll or other suitable coating means understood by those skilled in the art. The thickness of the coating ranges from about 0.0001 mil to about 10 mils with about 0.5 to about 1.5 mils being more preferred and about 0.9 to about 1.2 mils being yet still more preferred.

The coating of the present invention is applied generally without dilution but may be diluted such with the inclusion of water. A pH stabilizer and drying/wetting agent may also be added to enhance performance characteristics. Where additives are provided, the range of such additives ranges from about 0.01% to about 20% by weight with the amount of Sericol® ranging from approximately 99.99% to about 80% by weight.

The coating of the present invention is UV curable. UV curing is a technology that regularly evolves and efforts are continually sought out in order to achieve improved curing performance so that the printing operation may proceed at optimum speeds. That is, UV curing typically requires a “dwell time” in which the UV curable substance dries before it can be further processed in any additional equipment. As such, it is preferable to achieve faster curing speeds under a variety of difficult and complex environments so as to minimize if not completely eliminate the need for dwell or drying time.

Exemplary bulbs used in curing the slurry of the present invention are “H” bulbs and Gallium doped bulb suitable for use in the UV curing processes described herein, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for penetrating deep within the slurry mix. The UV bulbs such as those described above along with reflectors are available from the GEW Company, located in North Royalton, Ohio. The combination of topical and penetration curing result in a combination of curing energies sufficient to carry out the present invention.

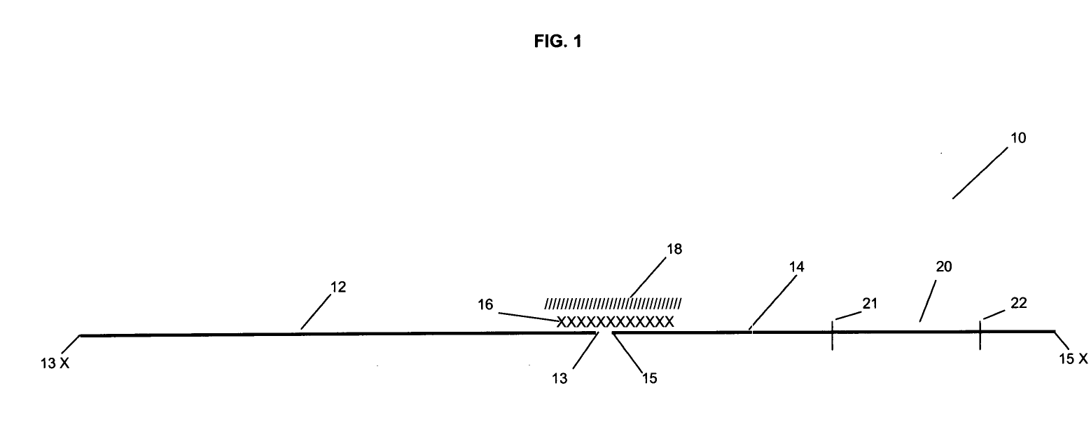

Turning now to FIG. 1, a side elevation of the form construction of the present invention is depicted. The business form assembly is depicted generally by reference to numeral 10. The business form assembly 10 includes first and second sections 12 and 14, respectively. Each of the sections 12 and 14 have end edges 13 and 13* and 15 and 15* respectively. As can be seen from FIG. 1, the sections 12 and 14 are substantially adjacent one another and do not overlap.

The sections 12 and 14 are joined to one another by a bonding agent 16, which in an exemplary arrangement includes the high performance acrylic tape discussed above. However, it should be understood that the bonding material or agent 16 may also include simply a pattern of adhesive, spots of tape or adhesive or combinations thereof. The bonding material 16 is then covered with coating 18, which in an exemplary embodiment includes IJR-701-1 as discussed above.

The bonding material and coating can be applied to either face or side of the business form construction depending on the manner in which the handling of the web is done.

One section that is to be used as the informational part of the business form construction may be selected from any suitable stock such as cellulosic based material including paper, card and tag stock, pressure sensitive material and the like. However, films, both plastic and metalized films are also suitable for use for the first portion. In an exemplary embodiment the material selected for the first portion ranges usually from 20 pound bond paper to 100 pound stock, typically tag or card stock. Generally, stock for the first portion is greater than 32 pound stock, but the invention is not so limited thereby. Where the first portion is a pressure sensitive material, film or metalized layer, a corresponding weight sheet is utilized in connection with the present assembly.

The business form assembly 10 of the present invention also has a second portion 14 which is formed of a material that is sufficient to die cut (21 and 22) one or more removable elements 20 such as cards as provided in the illustrative embodiment. The card arrangement can also be a self laminating construction in which after a recipient adds some additional indicia such as a signature, the recipient folds over the adjoining portion which adheres to the first card via adhesive exposed by the liner removal or other activation creating a protected card enclosure.

It should be understood that the type, shape, number and arrangement of the removable elements is discretionary and any such configuration may be used depending on the needs of the end user or particular application for which the removable elements are intended. While the card is generally considered to be a “wallet sized” card, one about the standard dimensions of a credit card, the card could also be larger such as to form an informational placard or alternatively could be much smaller such as useful in connection with a key tag or the like.

The material from which the second portion is selected may include paper stock to which a plastic like film, such as a MYLAR® or polyethylene coating has been applied to one or both surfaces of the paper or a plastic or film material. Alternatively, the second portion may be a synthetic material. In either event the thickness of the stock depends on the particular application of the end user and may range from 0.05 mil to 25 mils in thickness with about 1 to 3 mils being preferred. The width of the sheet of material may range from 0.1″ to about 5″ however, the material can have any approximate width depending on the configuration or geometric arrangement of the product and the pattern selected in connection with the manufacture and die cutting of the business form card assembly.

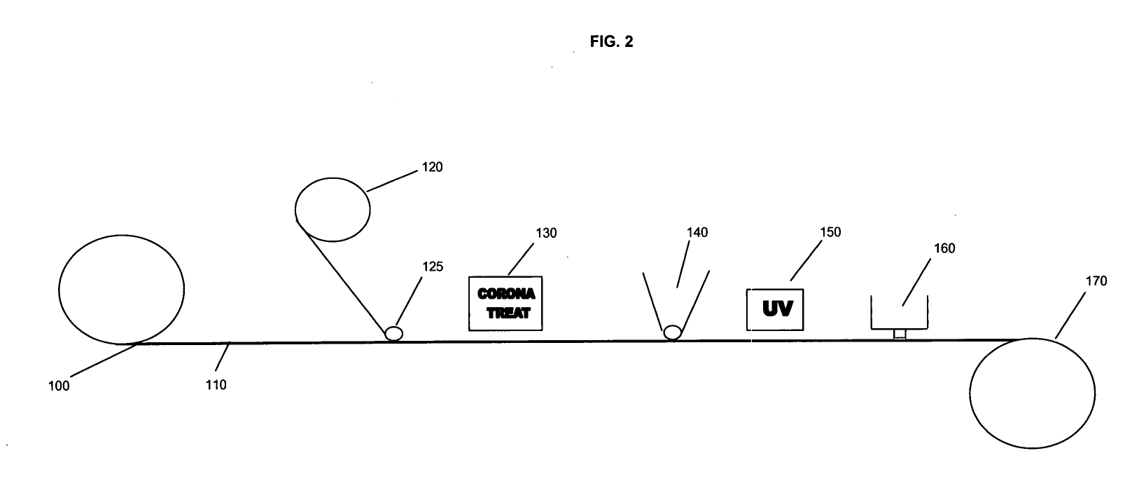

FIG. 2 provides a schematic of the manufacturing process by which the business form constructions of the present invention are created. The first and second substrates are unwound from a source 100. Typically, the material is unwound from two supply sources, one for the first web or substrate and the second for the second web or substrate. However, for simplicity a single source is illustrated in the FIGURE.

The webs of material 110 is advanced to the station 120 which applies the tape. The tape may be secured to the form assembly 110 through the use of a roller 125 or bar. Next, the form with the tape applied, that is the two sections of the form are now secured together in an adjacent configuration, is passed under a corona treatment zone shown at 130. The treatment serves to make the tape receptive to the coating that is to be applied in subsequent steps.

After the tape has been treated, the form, now a joined web assembly, is passed through the coating zone 140 where the tape is over coated. Alternatively, the edges of the tape or where an adhesive is used, the edges of the pattern of the adhesive may be covered with the coating material so as to prevent the adhesive from being exposed during processing. While the adhesive may not be exposed during the manufacture of the form, the adhesive may become exposed during processing or printing of the form as the pressure or fuser rollers or belts, for example in the printer (along with the heat generated during toner fusing), may cause the adhesive to soften and to ooze out from under the tape, thus causing the toner to stick to the adhesive area.

After the coating has been applied, the coating is subjected to treatment at a UV station 150 in order to cure and harden the coating in the area of application. Next, the business form assembly may undergo die cutting at station 160 to create the removable elements section of the assembly.

Finally, the form assembly 110 is then collected at a wind up station 170. Alternatively, the form assembly may undergo sheeting and individual forms created as opposed to providing the forms in a continuous, connected arrangement.

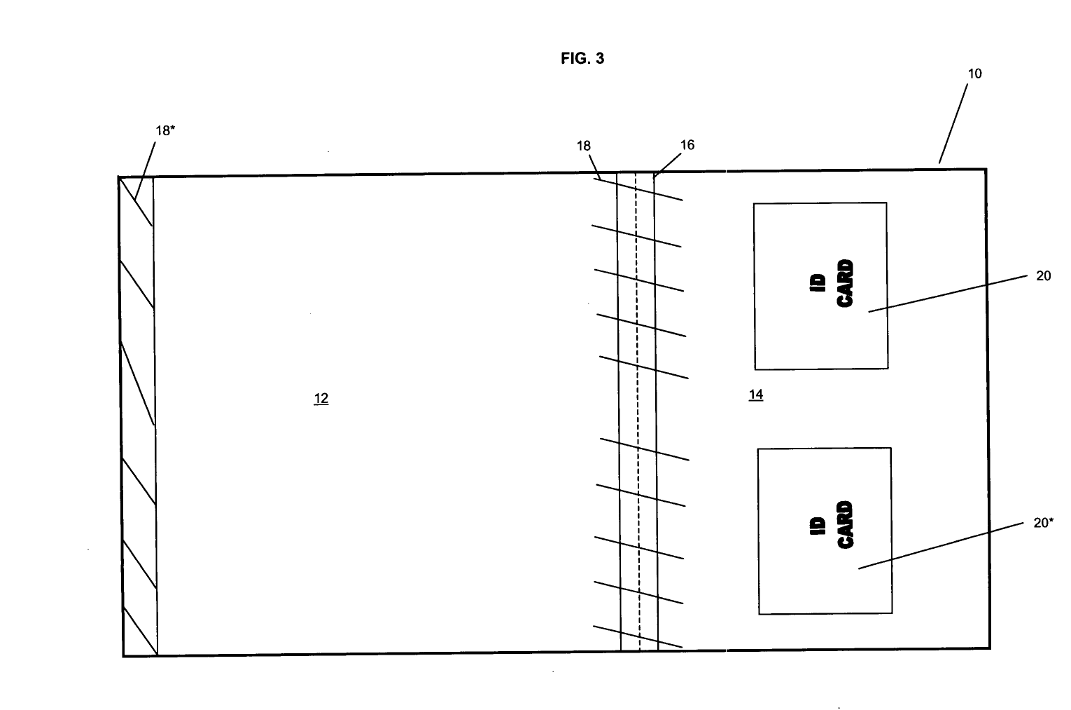

Turning to FIG. 3 of the presently described invention a front elevation of the business form assembly 10 is provided. The form 10 as already described includes first and second sections 12 and 14 which are arranged in an adjacent but not overlapping configuration. The outline of the tape 16 that is used is shown in addition to the over coating 18. FIG. 3 provides a side by side configuration of detachable cards 20 and 20* that are created by die cuts in the second section of the material to create removable elements. FIG. 3 also shows a supplemental pattern of coating 18* which may be used to offset the height or thickness differences of the two different types of sheet material or any thickness disparities created through the use of the bonding material. Such an arrangement would enable for a relatively square stack of sheets to be loaded into a feed tray such as for a printer or copier.

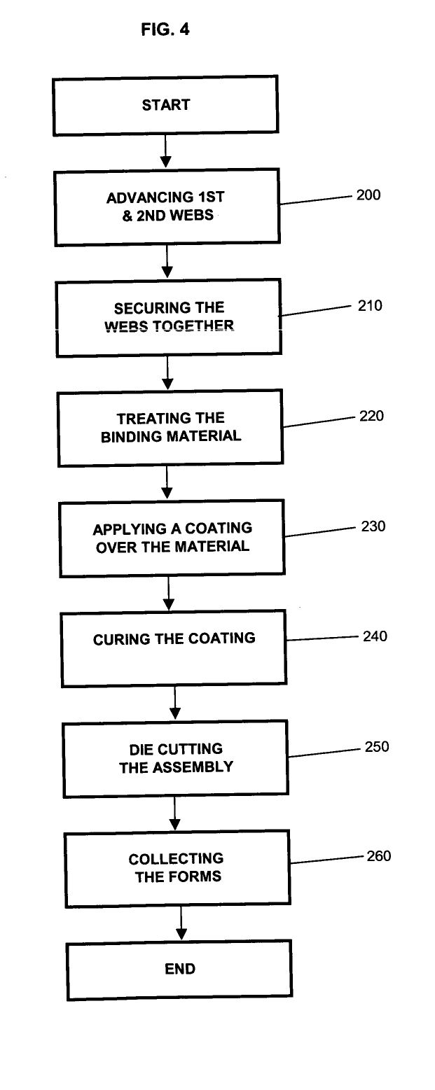

Attention is now directed to FIG. 4 of the instant specification which provides an exemplary method of practicing the invention. Once the process is commenced or started, the webs of materials are advanced at step 200. The webs are typically separate webs and are advanced independently yet synchronously with one another. That is, they travel at the same speeds.

Next, the first and second webs are secured together at step 210. The securing means including any suitable bonding material that will hold the first web in alignment with the second web such that an edge or side of each of the webs are adjacent one another but not overlapping.

After the bonding material has been applied, the material is subjected to a corona treatment to affix and more permanently bond the bonding material to the substrates at step 220. The web, now a joined web arrangement is advanced and a coating is applied over the top of the bonding material, or at least along the edges of the tape or adhesive pattern depending on which bonding material is used. The coating is accomplished at step 230.

The coating is then subjected to a curing step at step 240 in which ultraviolet (UV) energy is applied to the coating to cure and harden the coating and prevent the coating from flaking or breaking off from the coated area.

In order to create one or more removable elements, the web is die cut at step 250. It should be understood that the step of die cutting may occur at any stage of the process or the die cuts may be provided in one of the webs of material, prior to advancing the web of material to the processing station.

After the forms are prepared, they are collected at step 260. Collection of the forms may include sheeting the forms, cutting the forms into individual business form units, rewinding the forms so that they can be used in a continuous format or feeding the forms directly into processing or finishing equipment such as a printer, folder, sealer or the like business forms handling equipment.

In addition to cards, the foregoing business form may be provided with removable tags, coupons, wristbands or other means that may be useful in identification of participants in a particular program.

The business form construction may also be provided with additional coatings in areas such as on the leading and/or trailing edges of the business form assembly to offset any increase in thickness that the form assembly may have as a result of the different thicknesses of the substrates or in applying the bonding material and over coating.

It will thus be seen according to the present invention a highly advantageous business form card construction having one or more removable elements has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form construction, comprising;
a first generally planar substrate composed of a first material, said first substrate having first and second ends and first and second sides;
a second generally planar substrate composed of a second material and having first and second sides and first and second ends and said second substrate having at least one die cut defining at least a first removable element;
a material for securing said first and second substrates to one another along one of said first and second sides or first and second ends of each of said substrates; and
a coating applied over said material to prevent toner from substantially affixing to said material during imaging.

2. A business form as recited in claim 1, wherein said first substrate is selected from a group including stocks composed of substantially of cellulose.

3. A business form as recited in claim 1, wherein said second substrate is selected from a group including plastic and synthetic material.

4. A business form as recited in claim 1, wherein said material is a tape having adhesive on one side and having first and second side edges.

5. A business form as recited in claim 1, wherein said material is an adhesive.

6. A business form as recited in claim 4, wherein said adhesive is an acrylic adhesive.

7. A business form as recited in claim 4, wherein said tape is a polyethylene material.

8. A business form as recited in claim 1, wherein said coating is applied in an amount ranging from about 0.001 to about 10 mils.

9. A business form as recited in claim 1, wherein said material is applied in an area substantially adjacent one of said first and second sides or one of said first and second edges of each of first and second substrates.

10. A business form as recited in claim 8, wherein said coating is applied over said area of said material.

11. A business form as recited in claim 4, wherein said coating covers each of said first and second sides of said tape.

12. A business form as recited in claim 1, wherein said first and second are secured together such that said substrates are adjacent one another and not overlapping.

13. A method of producing a business form having at least one removable element, comprising the steps of;
advancing first and second webs of material;
securing said first and second webs together along one end edge or side edge of each of said substrate through use of a bonding material;
applying a coating over said bonding material to prevent toner tracking or peppering; and
collecting said business forms.

14. A method as recited in claim 13, including a further step of treating said bonding material with corona energy after the step of securing said first and second webs together.

15. A method as recited in claim 13, including a further step of curing said coating with UV energy after the step of applying the coating.

16. A method as recited in claim 13, including a further step of die cutting one of said first and second webs to produce at least one removable element prior to the step of collecting the business forms.

17. A method as recited in claim 13, including a further step of sheeting said business forms prior to the step of collecting the business forms to make individual business forms.

18. A method as recited in claim 13, wherein said bonding material includes an adhesive.

19. A business form intermediate, comprising;
a first cellulosic sheet having side edges and end edges;
a second sheet having a synthetic component and having side edges and end edges;
an adhesive bonding material connecting said first sheet to said second sheet along one of said side edges or said end edges such that said first and second sheets do not overlap with one another; and
a coating applied over said bonding material so as to cover at least edges of said bonding material.

20. A business form intermediate as recited in claim 19, wherein said intermediate is provided with an additional pattern of coating along at least one of a leading or trailing edge of said intermediate.
